(19) United States
(12) Patent Application Publication
(10) Pub. No.: US 2006/0260761 A1
(43) Pub. Date: Nov. 23, 2006

(54) Device for generating a preliminary bond for forming a laminated glass pane

(75) Inventors: Joachim Korswird, Bramsche (DE); Andreas Staubach, Leopoldshohe (DE)

Correspondence Address: BARNES & THORNBURG LLP, 750-17TH STREET NW, SUITE 900, WASHINGTON, DC, 20006-4675, US

(73) Assignee: Benteler Maschinenbau GmbH

(21) Appl. No.: 11/435,788

(22) Filed: May 18, 2006

(30) Foreign Application Priority Data
May 19, 2005 (DE) 102005022963.8-45

(51) Int. Cl. B30B 15/34

(52) U.S. Cl. 156/583.1

(57) ABSTRACT

A device for producing a preliminary composite, the preliminary composite including at least two glass panes and a plastic foil situated between the at least two glass panes. The plastic foil and the at least two glass panes are configured to form a laminated glass pane in an autoclave.

This non-provisional Application claims priority to and benefit of German Application No. 10 2005 022 963.8-45, filed May 19, 2005 in Germany, the disclosure of which is hereby incorporated by reference herein.

### BACKGROUND AND SUMMARY

The present disclosure relates to a device for producing a preliminary composite. The device includes at least two glass panes and a plastic foil situated in-between for forming a laminated glass pane in an autoclave. The device includes a transport element, a preheating duct, an adjoining first press rolling mechanism, a main heat duct, and an adjoining second press rolling mechanism.

The present disclosure provides for a device by which the manufacturing of preliminary composite units is possible for forming composite glass panes with a high productivity and a high product quality.

The device includes a preheating duct and a main heating duct equipped with heating units in the form of infrared radiators. Some of the latter are operated at a constant base load and the remainder are controllable for generating a desired working temperature. Control takes place by a pilot radiator having a temperature sensor spatially assigned directly to the pilot radiator, and having a controlling device and a thyristor-type power control device.

For the preliminary composite units to be formed in the device according to the present disclosure, a targeted heating is of decisive significance. In the preheating duct, a basic heating is endeavored such that, although the plastic foil is already being heated up, it does not yet adhere to the glass. It should still be possible for the air present in the foil layers to escape in a reliable manner. This air removal will then take place in a first press rolling mechanism connected on the output side.

In the main heating duct, a preliminary composite unit is then heated further, so that an adhesion is obtained between the glass panes and the plastic foils. In a second press rolling mechanism, a final subsequent air removal will then take place, and simultaneously the surrounding edges of a preliminary composite are sealed off, in that the glass panes are sealed virtually airtight by the plastic foil in the edge area.

An exact temperature control is of considerable importance for these operations. As a result of the device according to the present disclosure, this temperature control can be carried out in a precise manner because the infrared radiators are adjusted to a desired color temperature and can be kept constant as a result of the control. Since the heating of a preliminary composite requires certain expenditures of thermal energy, the temperature of the infrared radiators will drop during the passage of a preliminary composite. This temperature drop is determined directly at the pilot radiator by a temperature sensor. “Directly” should be understood in the sense of a detection of the above-mentioned temperature drop which is almost without any time delay. By the control device, this temperature drop is compared with the preadjusted desired color temperature and, by the resulting difference, more energy is fed to the infrared radiators by way of the thyristor-type power control device, so that an adaptation is again obtained to the desired preadjusted color temperature. The detection of the temperature drop directly at a pilot radiator is particularly advantageous because of the fast reaction to a temperature drop since, in the case of a measurement in the preheating duct or the main heating duct, a reaction would occur only with a considerable time delay, for example, after several minutes. This would finally lead to an insufficient heating of the preliminary composite including the plastic foil, so that a precise removal of air and a precise edge sealing would not be ensured. In such a case, increased rejection values would therefore have to be expected, which is naturally unacceptable with respect to the productivity of such a device.

According to an embodiment of the present disclosure, the infrared radiators, with a corresponding temperature control, are arranged above and below the transport device.

Thus, in the case of a respective preliminary composite unit, the pane distortion can be minimized because of an optimally adapted heating in the form of upper and lower heat. Pane distortion may occur as a result of the connection of two materials of different thermal expansions. This can be counteracted by a targeted heat treatment from above and below.

According to the present disclosure, targeted heat treatment of preliminary composite units is of considerable importance for the prefabrication of laminated glass panes.

Likewise, it is important that a preliminary composite, before being placed in an autoclave, in which it is subjected to relatively high pressures, has to be sealed in an airtight manner in the surrounding edge area. Specifically, in the event of an absence of the edge sealing, the compressed air of the autoclave may enter between the glass layers during the subsequent autoclave process, so that no pressure force can occur for producing the laminated glass.

In order to ensure an edge sealing before the placing into the autoclave, it is provided in the present disclosure that the press rolling mechanisms are each equipped with a contact pressure roller which can be acted upon by way of pressure medium cylinders in the direction of the assigned counterpressure rollers. In addition, irrespective of the size or the basic geometric shape of the preliminary composite material, the contact pressure rollers can always be pressed with the same contact pressure on the mutually opposite outer edges of the preliminary composite material onto the preliminary composite material.

According to the present disclosure, it is ensured that the surrounding edges are acted upon in a uniform manner with respect to pressure, so that a tight and secure edge sealing is obtained particularly in the second press rolling mechanism after the final subsequent air removal.

Other aspects of the present disclosure will become apparent from the following descriptions when considered in conjunction with the accompanying drawings.

### BRIEF DESCRIPTION OF THE DRAWINGS

FIG. 1 is a schematic lateral view of a device according to the present disclosure.

FIG. 2 is a diagrammatic view in the direction of the arrow II in FIG. 1.

FIG. 3 is a diagrammatic view in the direction of the arrow III in FIG. 2.

FIG. 4 is a diagrammatic view of a preheating or main heating duct with heating units for generating upper heat and lower heat, according to the present disclosure.

### DETAILED DESCRIPTION

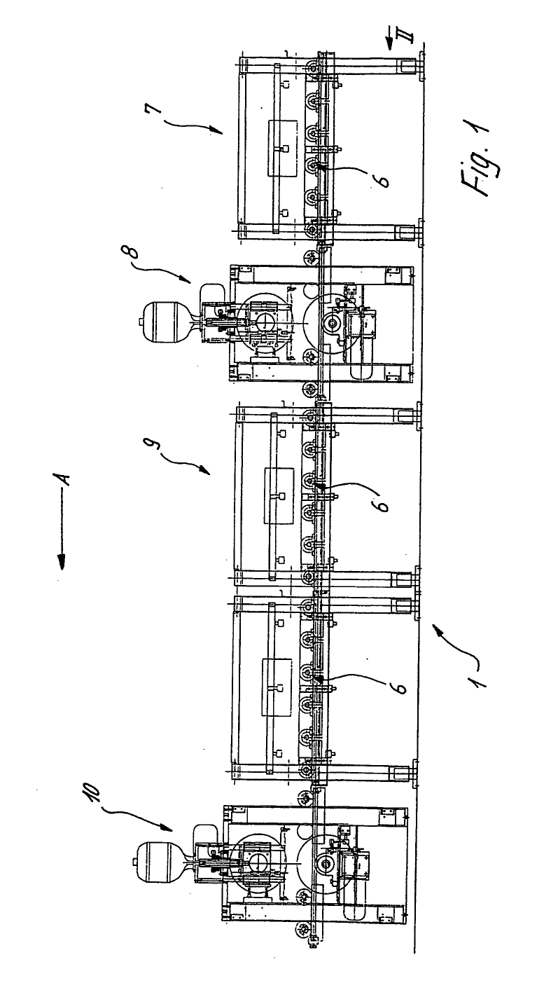

In FIG. 1, reference number 1 indicates the entire device for producing a preliminary composite for forming a laminated glass pane in a subsequent autoclave (not shown).

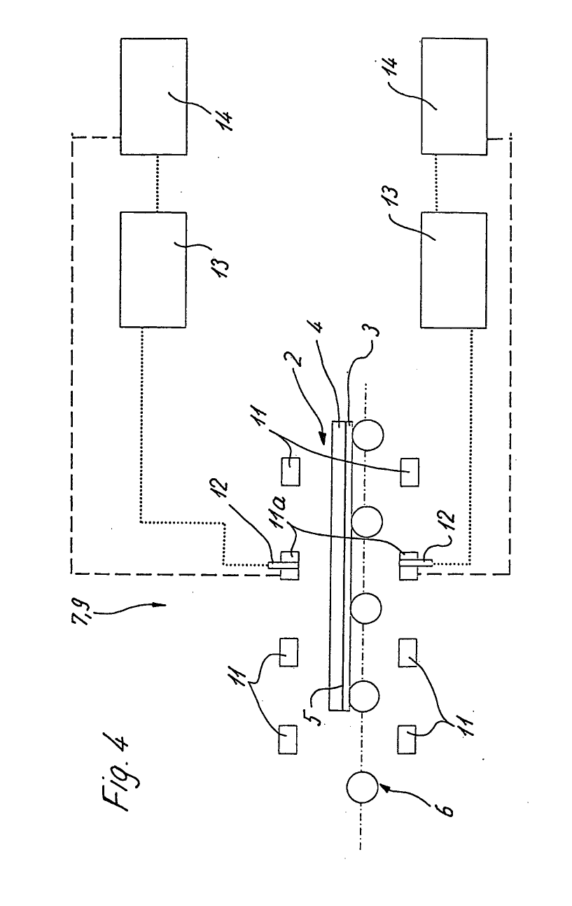

FIG. 4 shows a preliminary composite 2 including, for example, two glass panes 3 and 4 as well as a plastic foil 5 disposed in-between. It is within the scope of the present disclosure that preliminary composite 2 may include several layers, one plastic foil 5 always being situated between two glass panes 3, 4.

The preliminary composite 2 is transported through the entire device 1 by transport devices 6.

The entire device 1 comprises a preheating duct 7, a first press rolling mechanism 8, a main heating duct 9 and a second press rolling mechanism 10. The above-mentioned elements of the device 1 are listed in a direction of transport, as indicated by arrow A in FIGS. 1 and 3.

The device 1 is designed for first causing an air removal in an area between the glass panes 3 and 4 as well as the plastic foil 5 and subsequently producing an airtight sealing of at least the outer edges of the preliminary composite 2.

For this purpose, the preliminary composite 2 is first introduced into the preheating duct 7. In this preheating duct 7, a heating of the preliminary composite 2 is carried out which, however, does not yet result in a connection between the glass panes 3 and 4 and the plastic foil 5.

In the first press rolling mechanism 8, the air removal between the glass panes 3 and 4 and the plastic foil 5 is carried out.

Subsequently, the preliminary composite 2 arrives in an area of the main heating duct 9 in which another heating of the preliminary composite 2 is carried out in a temperature range in which a connection occurs between the glass panes 3 and 4, on the one hand, and the plastic foil 5, on the other hand.

In the second press rolling mechanism 10, an edge sealing is then carried out. That is, the preliminary composite 2 is pressed together in such a manner that at least the surrounding edges of the preliminary composite 2 are sealed off in an airtight manner.

The preliminary composite 2 produced in this manner can then finally be pressed together in an autoclave, which is not shown, to form a laminated glass pane.

So that this process can take place without any disturbances, it is important that the area between the individual glass panes 3 and 4 as well as the plastic foil 5 is perfectly freed of air and that a hermetic surrounding sealing of the edges has taken place.

For this purpose, two factors are relevant. On the one hand, it is of considerable importance that the heating of the preliminary composite 2 inside the preheating duct 7 and, therefore, before entry into the first press rolling mechanism 8 has to take place in a manner as precise and largely constant as that of the heating in the main heating duct 9 before entry into the second press rolling mechanism 10.

On the other hand, it is important, with respect to an interior of the press rolling mechanisms 8 and 10, that these press rolling mechanisms 8 and 10 are designed such that a uniform pressure can be exercised on the side edges of the preliminary composite 2.

FIG. 4 show elements which are used for a targeted heating of preliminary composite 2 inside a preheating duct 7 or a main heating duct 9.

According to an embodiment of the present disclosure, heating units in the form of several infrared radiators 11 are used.

Several infrared radiators 11 are arranged above and below the preliminary composite 2, so that an upper and a lower heat can be generated.

Such as arrangement is important if the thickness of the glass panes 3 and 4 or the material of these glass panes 3, 4 differs. For example, if at least one of the panes 3 or 4 is a pane made of polycarbonate and/or the connection layer is a foil made of polyurethane.

During an operation, the infrared radiators 11 are operated at a constant base load and thereby provide a certain temperature level which is slightly below a desired and preadjustable working temperature.

In order to then be able to reach this working temperature during the operation, by way of a pilot radiator 11a, the remaining number of infrared radiators 11 is then controlled as a function of the given operating conditions. This is done by the pilot radiator 11a being equipped with a temperature sensor 12 spatially directly assigned thereto, which temperature sensor 12 determines the effective temperature of the pilot radiator 11a. This temperature is compared with the preadjusted working temperature in a controlling device 13, and a resulting differential signal is used via a thyristor-type power control device 14 as a controlled variable for the power consumption of the pilot radiator 11a and of the infrared radiators 11 coupled therewith.

The detection of the temperature directly at the pilot radiator 11a represents a temperature detection virtually free of a loss of time and thereby offers the possibility of controlling the temperature of the preliminary composite 2 also without any significant delay such that this temperature is virtually constantly maintained at the desired working temperature. It thereby becomes possible, virtually without any significant time delay, to keep the required working temperature of the preliminary composite 2 constant, so that a processing speed of the entire device 1 can be considered to be relatively high.

A same arrangement of infrared radiators 11 and their control is provided in the main heating duct 9. In this respect, the main heating duct 9 differs from the preheating duct 7 only in that higher working temperatures are set in the main heating duct 9.

In order to ensure a uniform edge sealing of the surrounding edges of a preliminary composite 2, the first press rolling mechanism 8, like the second press rolling mechanism 10, is equipped with a stationary counterpressure roller 15 and a contact pressure roller 17 which can be acted upon by pressure medium cylinders 16 in a direction of the counterpressure roller 15. The pressure admission to the contact pressure rollers 17 is dimensioned such that it is always identical irrespective of the size or the basic geometric shape of the preliminary composite 2.

The preliminary composite 2 always runs parallel to a so-called reference edge 20, which is shown as a broken line in FIG. 3. The pressure medium cylinder 16 situated on a side of this reference edge 20 always acts with a defined contact pressure force upon the contact pressure roller 17.

Another pressure medium cylinder 16, which is situated opposite the reference edge 20, is a double-acting cylinder and can be acted upon by a pressure medium in a loading direction as well as against the loading direction.

For reaching a required contact pressure in the pane composite and while taking into account a dead weight, of the contact pressure rollers 17 on the side assigned to the reference edge 20, the upper pressure roller 17 is acted upon by a pressure medium with a constant pressure by a pertaining pressure cylinder 16 on a piston side by a pressure control device 16a.

For taking into account the dead weight of the pressure roller 17 on a side situated opposite the reference edge 20, a certain invariable pressure of the pressure medium is adjusted on the pressure control device 16a arranged on the rod side. By a measuring device 19, an effective width of the preliminary composite 2, that is, the respective current distance to the reference edge 20, is constantly measured, and this measuring result is transmitted to a control 18.

From this measured value, on the basis of lever conditions resulting from the effective width of the preliminary composite 2 and a roller length, it is now determined in the control 18 at which pressure of the pressure medium the pressure medium cylinder 16 facing away from the reference edge 20 should be acted upon by way of the proportional pressure control valve 21, so that effectively the same contact pressure always acts upon all outer edges of the preliminary composite 2. As a result, a secured reliable sealing of the surrounding edge area of the preliminary composite 2 is ensured. This can also take place during passage at relatively high process speeds.

Implemented tests have shown that, particularly in the case of laminated safety glass with a polycarbonate layer, a secure edge sealing is very important because the polyurethane foil to be used has a lower diffusion behavior than a PVB foil, and air can therefore be trapped more rapidly.

By the device 1, preliminary composite 2 can be produced at relatively high working speeds in a continuous pass. This preliminary composite 2 can easily and without additional resources be further processed at a high pressure to a laminated glass pane in an autoclave which follows.

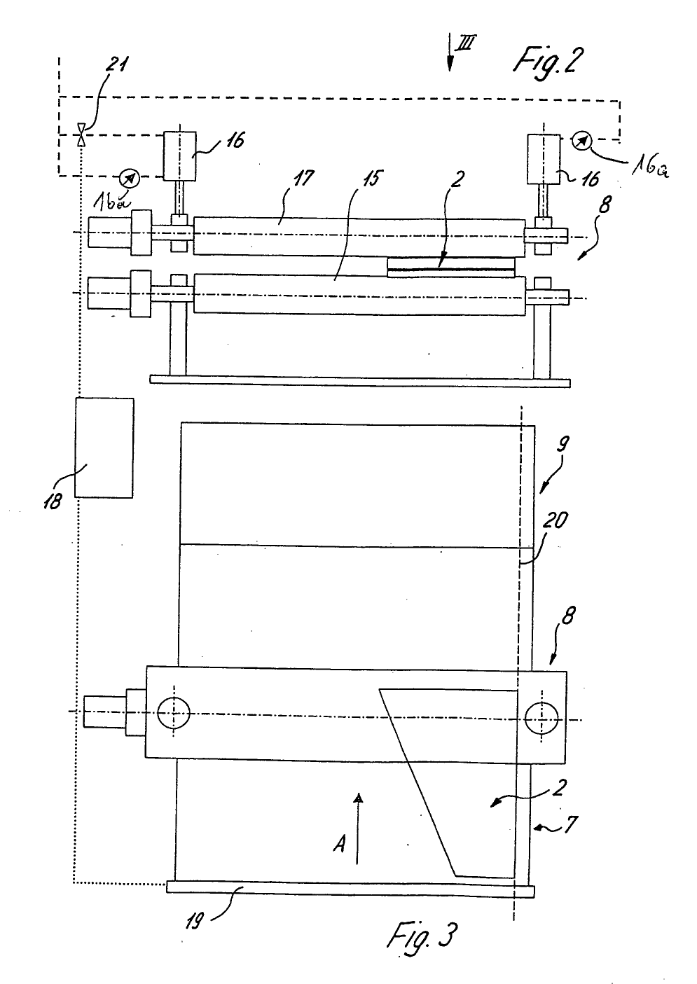

As shown in FIG. 2, the two pressure medium cylinders 16 are equipped with pressure control devices 16a. By the pressure control device 16a situated on the side of the reference edge 20, the corresponding pressure medium cylinder 16 is acted upon by a constant predetermined pressure. The pressure medium cylinder 16 which is situated opposite the reference edge 20, and is designed as a double-acting pressure medium cylinder, is acted upon by pressure by the pressure control device 16a against the contact pressure direction such that the dead weight of the contact pressure roller 17 at this point is virtually canceled. By proportional pressure control valve 21, while taking into account all measured quantities to be included in the control 18, particularly the results of the measuring device 19, the corresponding pressure medium cylinder 16 is then acted upon by pressure such that the outer edge of a preliminary composite 2 situated opposite the reference edge 20 is acted upon by virtually the same pressure as the outer edges situated in the area of the reference edge 20.

Although the present disclosure has been described and illustrated in detail, it is to be clearly understood that this is done by way of illustration and example only and is not to be taken by way of limitation. The scope of the present disclosure is to be limited only by the terms of the appended claims.

1. A device for producing a preliminary composite, the preliminary composite including at least two glass panes and a plastic foil situated between the at least two glass panes, the plastic foil and the at least two glass panes configured to form a laminated glass pane in an autoclave, the device comprising:
a transport device;
an adjoining first press rolling mechanism;
an adjoining second press rolling mechanism;
a preheating duct and a main heating duct, each including infrared radiators;
at least one of the infrared radiators being operated at a constant base load; and
at least one of the infrared radiators including a control for generating a desired working temperature, the control being a pilot radiator having a temperature sensor assigned directly to the pilot radiator and having a control device and a thyristor-type power control device.

2. The device according to claim 1, wherein the infrared radiators having a corresponding temperature control are arranged above and below the transport device.

3. The device according to claim 1, wherein the first and second press rolling mechanisms each include a contact pressure roller arranged to be acted upon by pressure medium cylinders in a direction of assigned counterpressure rollers, and that, irrespective of a size or geometric shape of the preliminary composite, the contact pressure rollers are arranged to be pressed with equal contact pressure on mutually opposite outer edges of the preliminary composite onto the preliminary composite.

4. The device according to claim 3, wherein the contact pressure of the contact pressure rollers is controlled by a control which takes into account an effective width of the preliminary composite measured in a passage direction of the preliminary composite as well as a lever force resulting from a dead weight of the contact pressure rollers and the effective width of the preliminary composite.

5. The device according to claim 3, wherein a first of the pressure medium cylinders is situated in the area of a reference edge and is constructed as a single-acting pressure medium cylinder constantly loaded by a preadjusted pressure.

6. The device according to claim 5, wherein one of the pressure medium cylinders faces away from the reference edge and is constructed as a double-acting pressure medium cylinder.

7. The device according to claim 6, wherein each of the pressure medium cylinders is configured to be acted upon by a pressure control device by a predetermined pressure, and the double-acting pressure medium cylinder situated opposite the reference edge is acted upon by one of the pressure control devices against a contact pressure direction by a pressure canceling a dead weight of one of the contact pressure rollers and by a contact pressure being applied by a proportional pressure control valve influenced by a control that takes into account a measuring device detecting an effective width of the preliminary composite.

8. The device according to claim 3, further including a measuring device configured to detect an effective width of the preliminary composite and a control that, based upon the effective width of the preliminary composite, adjusts the contact pressure on the pressure medium cylinder situated opposite a reference edge to achieve equal contact pressure on the mutually opposite outer edges of the preliminary composite.
